(19) United States
(12) Patent Application Publication
(10) Pub. No.: US 2025/0375861 A1
(43) Pub. Date: Dec. 11, 2025

(54) Dongle for an Electronic Torque Wrench

(71) Applicant: Apex Brands, Inc., Apex, NC (US)

(72) Inventors: Bin Sun, Shanghai (CN); Henglian Luo, Shanghai (CN)

(21) Appl. No.: 19/108,004

(22) PCT Filed: Sep. 1, 2022
(86) PCT No.: PCT/CN2022/116475

§ 371 Date: Feb. 28, 2025

(51) Int. Cl. B25B 23/142

(52) U.S. Cl. CPC B25B 23/1425

(57) ABSTRACT

A dongle is provided for an electronic torque wrench configured to determine a torque value of an applied torque, and present information including the torque value. The dongle includes first and second communication interfaces, an electronic visual display and processing circuitry. The first communication interface includes a plug configured to fit a receptacle of the electronic torque wrench, and the second communication interface includes an antenna configured to enable data transmission from the dongle to a computer, wirelessly by radio communication. The processing circuitry is configured to read the information from the electronic torque wrench to the dongle via the first communication interface, and generate second information from the information. The processing circuitry is configured to transmit the second information from the dongle to the computer via the second communication interface. And the processing circuitry is configured to and cause the electronic visual display to present the second information.

### TECHNOLOGICAL FIELD

The present disclosure relates generally to torque application and measurement devices and, in particular, to a dongle for a torque measurement device such as an electronic torque wrench.

### BACKGROUND

Fasteners are often used to assemble performance critical components are tightened to a specified torque level to introduce a “pretension” in the fastener. As torque is applied to the head of the fastener, the fastener may begin to stretch beyond a certain level of applied torque. This stretch results in the pretension in the fastener which then holds the components together. Additionally, it is often necessary to further rotate the fastener through a specified angle after the desired torque level has been applied. A popular method of tightening these fasteners is to use a torque wrench.

Torque wrenches may be of mechanical or electronic type. Mechanical torque wrenches are generally less expensive than electronic. There are two common types of mechanical torque wrenches, beam and clicker types. In a beam type torque wrench, a beam bends relative to a non-deflecting beam in response to applied torque. The amount of deflection of the bending beam relative to the non-deflecting beam indicates the amount of torque applied to the fastener. Clicker type torque wrenches have a selectable preloaded snap mechanism with a spring to release at a specified, target torque, thereby generating a click noise to alert the operator to release force on the wrench from which the applied torque is produced.

Electronic torque wrenches tend to be more expensive than mechanical torque wrenches. Many electronic torque wrenches include a user interface with a human input device and an electronic visual display. The electronic torque wrench may receive a target torque through its user interface; and when applying torque to a fastener with an electronic torque wrench, torque readings may be indicated on the electronic visual display that relate to the pretension in the fastener due to the applied torque. The electronic torque wrench may also alert the operator to release the force on the wrench when the applied torque reaches the target torque.

Although electronic torque wrenches provide a number of useful features, it is generally desirable to improve on existing designs.

### BRIEF SUMMARY

Example implementations of the present disclosure are directed to a dongle for a torque measurement device such as an electronic torque wrench. The present disclosure includes, without limitation, the following example implementations.

Some example implementations provide a dongle for an electronic torque wrench configured to determine a torque value of an applied torque, and present information including the torque value, the dongle comprising: a first communication interface that includes a plug configured to fit a receptacle of the electronic torque wrench, and thereby enable data transmission from the electronic torque wrench to the dongle; and a second communication interface that includes an antenna configured to enable data transmission from the dongle to a computer, wirelessly by radio communication; an electronic visual display; and processing circuitry coupled to the first communication interface, the second communication interface and the electronic visual display, the processing circuitry configured to at least: read the information from the electronic torque wrench to the dongle via the first communication interface; generate second information from the information; transmit the second information from the dongle to the computer via the second communication interface; and cause the electronic visual display to present the second information.

Some example implementations provide a method of operating an electronic torque wrench configured to determine a torque value of an applied torque, and present information including the torque value, the method comprising: connecting the electronic torque wrench to a dongle that includes a first communication interface to enable data transmission from the electronic torque wrench to the dongle, and that includes a second communication interface to enable data transmission from the dongle to a computer, wirelessly by radio communication; and at the dongle, reading the information from the electronic torque wrench to the dongle via the first communication interface; generating second information from the information; transmitting the second information from the dongle to the computer via the second communication interface; and causing an electronic visual display of the dongle to present the second information.

These and other features, aspects, and advantages of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable unless the context of the disclosure clearly dictates otherwise.

It will therefore be appreciated that this Brief Summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects and advantages will become apparent from the following detailed description taken in conjunction with the accompanying figures which illustrate, by way of example, the principles of some described example implementations.

### BRIEF DESCRIPTION OF THE FIGURE(S)

Having thus described example implementations of the disclosure in general terms, reference will now be made to the accompanying figures, which are not necessarily drawn to scale, and wherein:

FIGS. 1A and 1B illustrate an electronic torque wrench, according to some example implementations of the present disclosure;

FIG. 2 is a block diagram of a torque measurement device that may correspond to the electronic torque wrench of FIG. 1, according to some example implementations;

FIG. 3 illustrates a system for operating a torque measurement device such as an electronic torque wrench, according to various example implementations;

FIG. 4 more particularly illustrates a dongle of the system of FIG. 3, according to various example implementations;

FIGS. 5 and 6 illustrate views of an electronic visual display of the dongle, according to various example implementations; and

FIGS. 7A, 7B, 7C, 7D, 7E, 7F, 7G and 7H are flowcharts illustrating various steps in a method of operating an electronic torque wrench, according to various example implementations.

### DETAILED DESCRIPTION

Some implementations of the present disclosure will now be described more fully hereinafter with reference to the accompanying figures, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. Like reference numerals refer to like elements throughout.

Unless specified otherwise or clear from context, references to first, second or the like should not be construed to imply a particular order. A feature described as being above another feature (unless specified otherwise or clear from context) may instead be below, and vice versa; and similarly, features described as being to the left of another feature else may instead be to the right, and vice versa. Also, while reference may be made herein to quantitative measures, values, geometric relationships or the like, unless otherwise stated, any one or more if not all of these may be absolute or approximate to account for acceptable variations that may occur, such as those due to engineering tolerances or the like.

As used herein, unless specified otherwise or clear from context, the “or” of a set of operands is the “inclusive or” and thereby true if and only if one or more of the operands is true, as opposed to the “exclusive or” which is false when all of the operands are true. Thus, for example, “[A] or [B]” is true if [A] is true, or if [B] is true, or if both [A] and [B] are true. Further, the articles “a” and “an” mean “one or more,” unless specified otherwise or clear from context to be directed to a singular form. Furthermore, it should be understood that unless otherwise specified, the terms “data,” “content,” “digital content,” “information,” and similar terms may be at times used interchangeably.

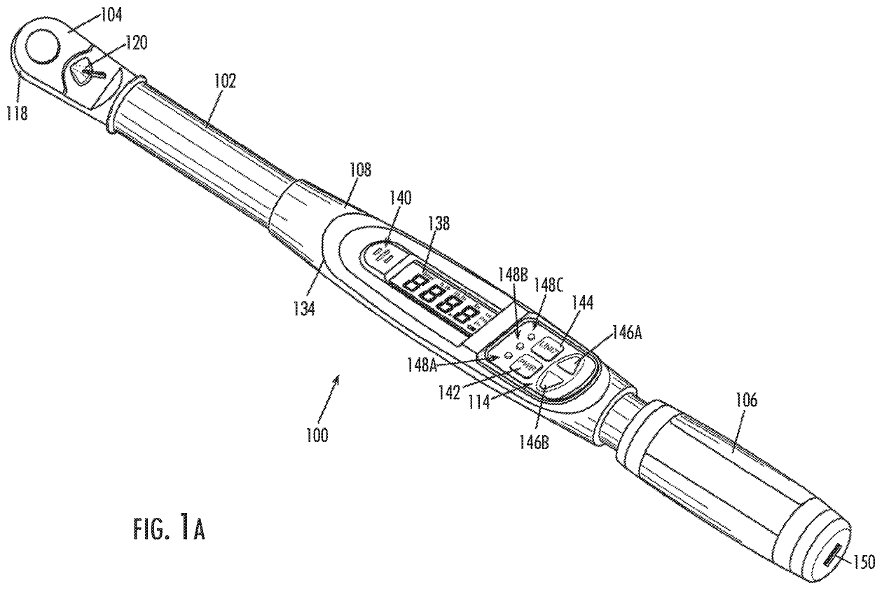

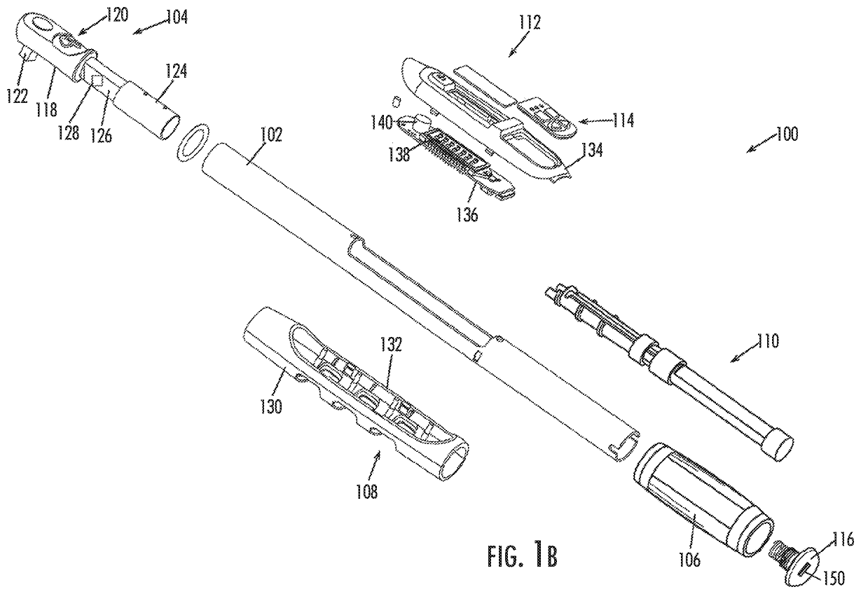

Example implementations of the present disclosure relate generally to torque application and measurement devices. Example implementations will primarily be described in the context of an electronic torque wrench. Other examples of suitable torque measurement devices include a torque tester, torque meter, torque transducer or the like. FIGS. 1A and 1B illustrate an electronic torque wrench 100 according to some example implementations of the present disclosure. As shown, the electronic torque wrench includes a wrench body 102, a wrench head 104 (e.g., a ratcheting wrench head), a grip handle 106, a housing 108, a battery assembly 110, and an electronics unit 112 with a user interface 114. In some examples, the wrench body is of tubular construction, made of steel or other rigid material, and receives the wrench head at a first end and the battery assembly at a second end, secured therein by an end cap 116. In some of these examples, the housing is mounted therebetween and carries the electronics unit.

As shown, a front end 118 of the wrench head 104 includes a coupler with a lever 120 that allows a user to select whether torque is applied to a fastener in either a clockwise (CW) or counter-clockwise (CCW) direction. The front end also includes a male square drive or boss 122 for receiving variously sized sockets, extensions, etc. A rear end 124 of the wrench head is slidably received in the wrench body 102 and rigidly secured therein. The wrench head includes at least one vertical flat portion 126 formed between the front end and the rear end for receiving a strain gauge assembly 128. The flat portion of the wrench head is both transverse to the plane of rotation of torque wrench 100 and parallel to the longitudinal center axis of the wrench head. The strain gauge assembly includes one or more strain gauges. In some examples, the strain gauge assembly is a full-bridge assembly including four separate strain gauges on a single film that is secured to the flat portion of the wrench head. Together, the full-bridge strain gauge assembly mounted on the flat portion of the wrench head is referred to as a strain tensor.

As also shown, the housing 108 includes a bottom portion 130 that is slidably received about the wrench body 104 and defines an aperture 132 for receiving a top portion 134 that carries the electronics unit 112. The electronics unit provides the user interface 114 for the operation of the electronic torque wrench 100. The electronics unit includes a circuit board 136 including an electronic visual display 138 and an annunciator 140 mounted thereon. The portion of the housing defines an aperture that receives the user interface, which includes a power button 142, a unit selection button 144, increment/decrement buttons 146A and 146B, and three light emitting diodes (LEDs) 148A, 148B and 148C. And the LEDs may illuminate green, yellow and red, respectively, when activated.

In some examples, the electronic torque wrench 100 includes a communication interface to enable data transmission between the electronic torque wrench and various computers or computer hardware. The communication interface may be or include an electronic circuit, and a cable connector such as a female cable connector, receptacle 150 or the like to connect the electronic torque wrench to a computer/computer hardware, and enable data transmission between the electronic torque wrench and the computer/computer hardware by wire. One example of a suitable communication interface is a serial data interface such universal serial bus (USB). The receptacle may be secured to the electronic torque wrench at any of a number of different locations, including in the end cap 116 as shown.

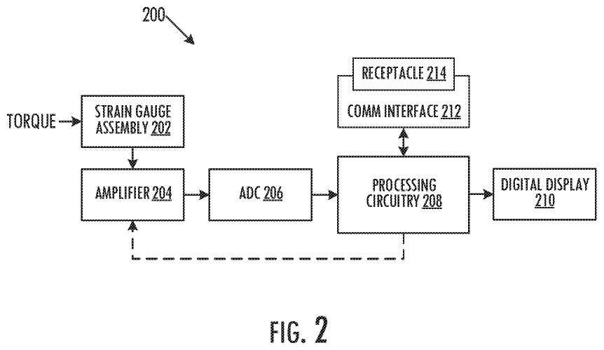

FIG. 2 illustrates a torque measurement device 200 for determining a torque value of an applied torque, according to some example implementations. The torque measurement device may be embodied in a number of different manners, and in some examples, the torque measurement device is an electronic torque wrench such as electronic torque wrench 100. In other examples, the torque measurement device is a torque tester, torque meter, torque transducer or the like. As shown, the torque measurement device includes a strain gauge assembly 202 (e.g., strain gauge assembly 128), an amplifier 204, an analog-to-digital converter (ADC) 206, and processing circuitry 208. In some examples in which the torque measurement device 200 corresponds to electronic torque wrench 100, the amplifier ADC and processing circuitry may be components of the electronics unit 112, carried by the circuit board 136.

The strain gauge assembly 202 is configured to measure an applied torque such as the torque applied to a fastener when the torque measurement device 200 is an electronic torque wrench, and produce an analog electrical signal that varies in voltage with the torque. The amplifier 204 is configured to receive the analog electrical signal, and increase an amplitude of the analog electrical signal to produce an amplified, analog electrical signal.

The ADC 206 is configured to convert the amplified, analog electrical signal to an equivalent digital electrical signal. The processing circuitry 208, then, is configured to determine the torque value of the torque applied to the fastener from the equivalent digital electrical signal, and output an indication of the torque value. In some examples, the equivalent digital electrical signal includes digital data points; and in some of these examples, the processing circuitry is configured to determine a subset of the digital data points in a moving sample window, and calculate the torque value from a rolling average of the subset of the digital data points in the moving sample window.

The processing circuitry 208 may output the indication of the torque value in a number of different manners. In some examples, the torque measurement device 200 further includes an electronic visual display 210 (e.g., electronic visual display 138), and the processing circuitry is configured to output the indication of the torque value to the electronic visual display that is configured to present the torque value.

As also shown, the torque measurement device 200 may include a communication interface 212 is configured to enable data transmission between the torque measurement device and various computers or computer hardware. This communication interface may be the same as or similar to the communication interface of the electronic torque wrench 100, one suitable example of which is USB. And in this regard, the communication interface may include a cable connector such as a female cable connector, receptacle 214 or the like.

To further illustrate calculation of the torque value according to various example implementations, consider an example in which the processing circuitry 208 samples one thousand digital data points per second and uses a moving sample window of ten milliseconds. As torque is applied, the processing circuitry may average the first ten digital data points, one taken each millisecond, thereby producing a first equivalent digital value at time t=0.01 seconds, wherein t=0.0 seconds marks initiation of the torquing operation. At time t=0.011 seconds, the processing circuitry may average the digital data points taken between times t=0.002 and t=0.011 seconds, thereby producing a second equivalent digital value. At time t=0.012 seconds, the processing circuitry may average the digital data points taken between times t=0.003 seconds and t=0.012 seconds, thereby producing a third equivalent digital value. And this may continue such that an equivalent digital value may be provided every millisecond until the torque is no longer applied. In short, the processing circuitry may utilize a digital filtering algorithm to provide a rolling average in which the oldest digital data point is dropped each time a new digital data point is received within the moving sample window.

In some examples, the processing circuitry 208 may utilize the equivalent digital values and a calibration function to calculate the torque value. One example of a suitable calibration function includes a plurality of line segments for use by the processing circuitry to convert the digital values of the equivalent digital electrical signals into equivalent torque values, according to some example implementations. In this regard, after assembly, each torque measurement device 200 may be calibrated in order to derive the calibration function. The torque measurement device may be used to measure known applied torque values at various points along an interval of torque values ranging from 0 to 100% of a preset maximum torque. The data points for the interval of torque values provide three different line segments of the graph of which the slopes (m) and y-intercepts (b) can be found using the equation y=m(x)+b. The calibration function may be defined to include the linear functions for the line segments, which may be stored in memory and used by the processing circuitry to determine equivalent torque values based on the equivalent digital values.

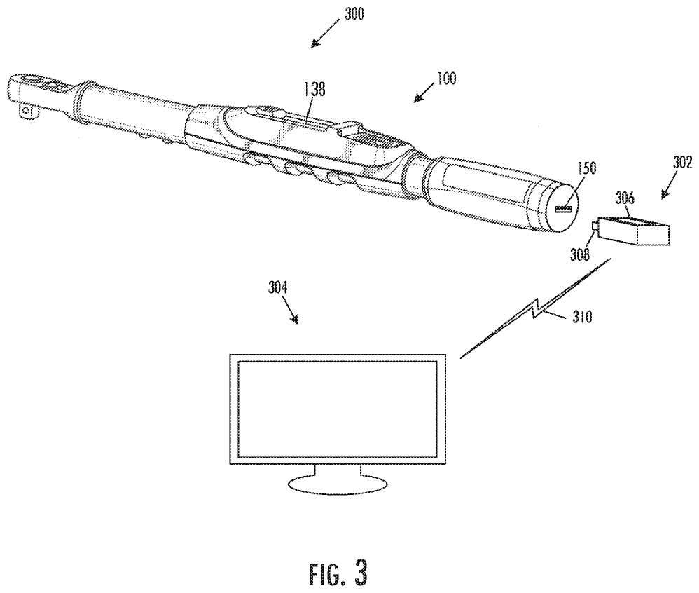

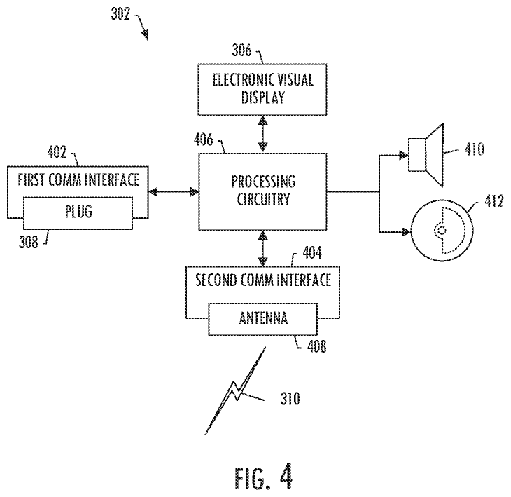

FIG. 3 illustrates a system 300 for operating a torque measurement device 200 such as an electronic torque wrench 100, according to various example implementations. The torque measurement device is configured to determine a torque value of an applied torque, and present information including the torque value such as on its electronic visual display 210 (e.g., electronic visual display 138). As shown, the system includes the an electronic torque wrench, a dongle 302 and a computer 304. The dongle is generally configured to enable wireless functionality on the electronic torque wrench or other torque measurement device that does not have built-in wireless functionality. FIG. 4 more particularly illustrates a suitable dongle according to some example implementations.

Referring to FIGS. 3 and 4, in some examples, the dongle 302 includes a first communication interface 402, a second communication interface 404, an electronic visual display 306, and processing circuitry 406 coupled to the first communication interface, the second communication interface and the electronic visual display. The first communication interface The first communication interface may be or include an electronic circuit, and include a cable connector such as a male cable connector, a plug 308 or the like configured to fit the receptacle 150 of the electronic torque wrench 100, and thereby enable data transmission from the electronic torque wrench to the dongle. Similar to above, example of a suitable communication interface is a serial data interface such USB.

The second communication interface 404 includes an antenna 408 configured to enable data transmission from the dongle to the computer 304, wirelessly by radio communication. In this regard, the second communication interface may enable data transmission over a wireless data link 310 between the dongle and the computer. The second communication interface may be configured according to any of a number of wireless communication standards such as Bluetooth®, Bluetooth low energy (Blueetooth LE), Zigbee®, Wi-Fi® and the like.

According to various example implementations in which the electronic torque wrench 100 or other torque measurement device is configured to present information including a torque value of an applied torque, the processing circuitry 406 of the dongle 302 is configured to read the information from the electronic torque wrench to the dongle via the first communication interface 402. In some examples, the electronic torque wrench includes separate processing circuitry (e.g., electronics unit 112, processing circuitry 208) configured to send an electrical signal that carries the information to a separate electronic visual display (e.g., electronic visual display 138, 210) on which the information is presented; and in some of these examples, the processing circuitry 406 is configured to read the electrical signal and thereby the information.

The processing circuitry 406 is configured to generate second information from the information. The processing circuitry is then configured to transmit the second information from the dongle 302 to the computer 304 via the second communication interface 404, and cause the electronic visual display 306 of the dongle to present the second information.

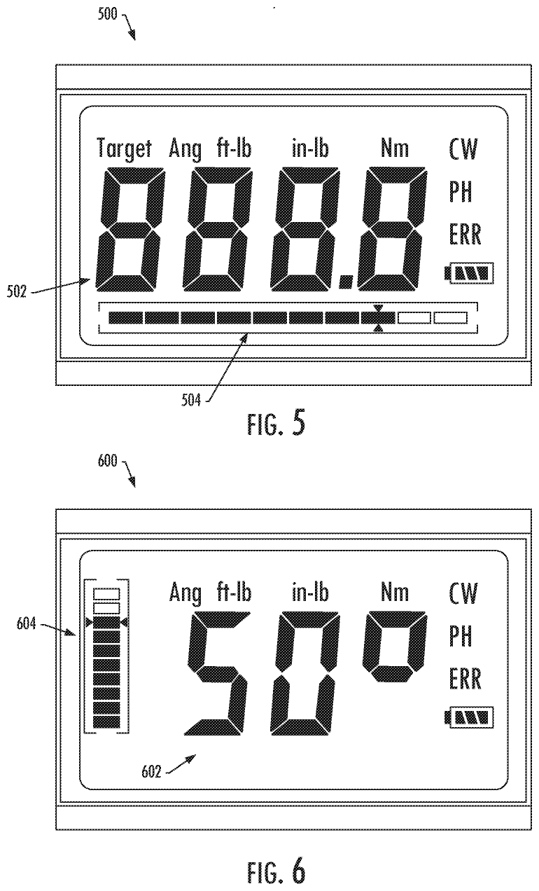

In various examples, the torque value with the information read from the electronic torque wrench 100 is a peak torque value or a current torque value. In some examples, the torque value is a peak torque value or a current torque value, and the information the processing circuitry 406 is configured to read from the electronic torque wrench includes the peak torque value and the current torque value. And in some examples further, the peak torque value is expressed as a numeric value, and the current torque value is expressed as a bar graph that indicates the current torque value relative to a preset target torque value. FIG. 5 illustrates a view 500 of the electronic visual display 306 of the dongle 302 in which the peak torque value may be expressed as a numeric value 502, and the current torque value may be expressed as a bar graph 504 that indicates the current torque value relative to a preset torque value. As shown, the bar graph includes a number of blocks, and a subset of the number of blocks are filled to represent a corresponding fraction of the current torque value relative to the preset torque value.

In some examples, the electronic torque wrench 100 is further configured to determine an angle value of an accumulated angular rotation of the electronic torque wrench during the applied torque, and the information read from the electronic torque wrench (to the dongle 302) also includes the angle value. In some of these examples, the angle value is expressed as either or both of a numeric value, or a bar graph that indicates the angle value relative to a preset target accumulated angle value. FIG. 6 illustrates a view 600 of the electronic visual display 306 of the dongle 302 in which the angle value may be expressed as a numeric value 602, and as a bar graph 604 that indicates the angle value relative to a preset target accumulated angle value. Similar to above, the bar graph includes a number of blocks, and a subset of the number of blocks are filled to represent a corresponding fraction of the angle value relative to the preset target accumulated angle value.

In some examples, the dongle 302 further includes either or both of a loudspeaker 410 or vibrator 412. In some of these examples, the processing circuitry 406 is further configured to cause one or more of the electronic visual display, loudspeaker or vibrator to generate a visual, audible or haptic alert when the torque value reaches a preset target torque value. Similarly, in some examples, the processing circuitry is further configured to cause the electronic visual display, loudspeaker or vibrator to generate a visual, audible or haptic alert when the angle value reaches a preset target accumulated angle value.

In some examples, the second information generated by the processing circuitry 406 of the dongle 302 is a duplicate of the information and includes the torque value (e.g., peak torque value, current torque value). In other examples, the processing circuitry is configured to apply the torque value to a function to determine an adjusted torque value, and the second information includes the adjusted torque value (e.g., adjusted peak torque value, adjusted current torque value). In some further examples in which the torque value is a peak torque value and the adjusted torque value is an adjusted peak torque value, the information the processing circuitry 406 is configured to read from the electronic torque wrench 100 also includes a current torque value. The processing circuitry may then also apply the current torque value to the function to determine an adjusted current torque value, with the second information including the adjusted peak torque value and the adjusted current torque value. Either or both of these values may be expressed in a manner similar to the peak torque value or current torque value as described above and shown for example in FIG. 5. Likewise, the processing circuitry 406 may be configured to cause one or more of the electronic visual display 306, loudspeaker 410 or vibrator 412 to generate a visual, audible or haptic alert when the adjusted torque value reaches a preset target torque value.

The dongle 302 being configured to adjust the torque value (e.g., peak torque value, current torque value) may have an effect similar to a recalibration of the electronic torque wrench when the calibration function onboard the electronic torque wrench is otherwise inaccessible to the operator. In this regard, the dongle 302 may be operable in a calibration mode in which the processing circuitry 406 is further configured to read the information including the torque value of the applied torque from the electronic torque wrench 100. The processing circuitry may be configured to then derive the function that maps the torque value to a corresponding reference torque value. In even further examples, the information including the torque value may be read for a plurality of applied torques across a rated torque range of the electronic torque wrench 100, and the function is derived from the torque value and corresponding reference torque values for the plurality of applied torques.

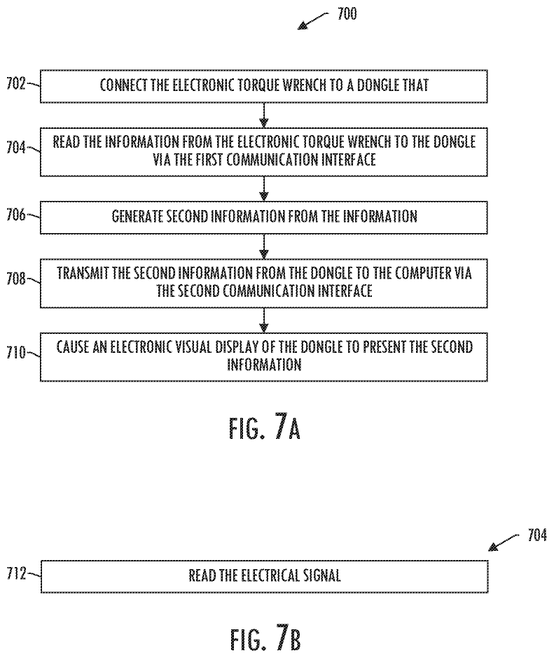

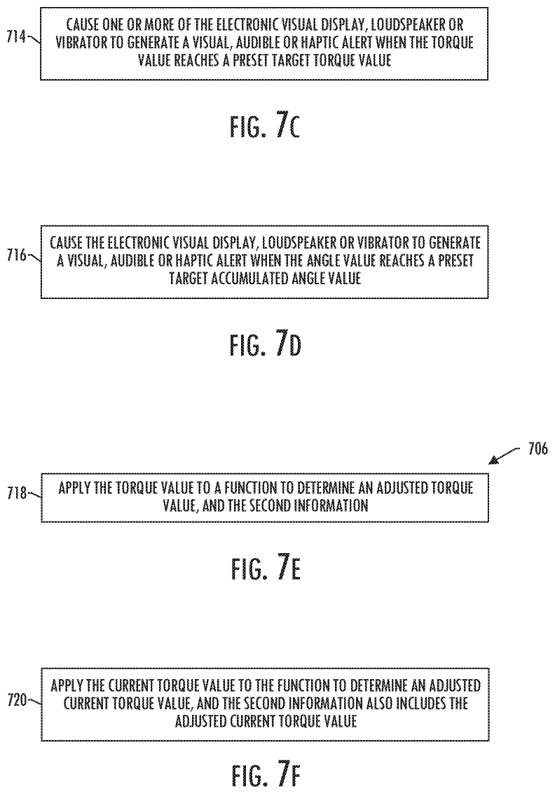

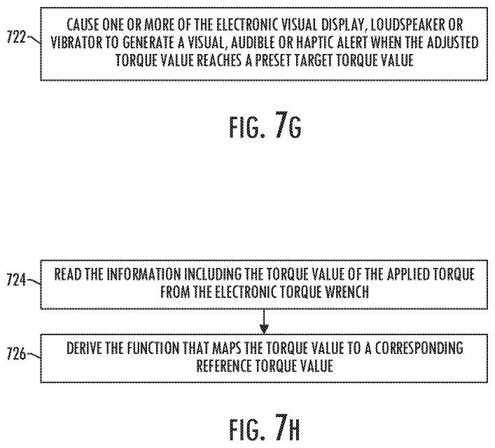

FIGS. 7A-7H are flowcharts illustrating various steps in a method 700 of operating an electronic torque wrench configured to determine a torque value of an applied torque, and present information including the torque value, according to various example implementations. The method includes connecting the electronic torque wrench to a dongle, as shown at block 702 of FIG. 7A. The dongle includes a first communication interface to enable data transmission from the electronic torque wrench to the dongle, and the dongle includes includes a second communication interface to enable data transmission from the dongle to a computer, wirelessly by radio communication. The method includes, at the dongle, reading the information from the electronic torque wrench to the dongle via the first communication interface, as shown at block 704. The method includes generating second information from the information, as shown at block 706. The method includes transmitting the second information from the dongle to the computer via the second communication interface, as shown at block 708. And the method includes causing an electronic visual display of the dongle to present the second information, as shown at block 710.

In some examples, the electronic torque wrench includes separate processing circuitry configured to send an electrical signal that carries the information to a separate electronic visual display on which the information is presented. In some of these examples, reading the information at block 704 includes reading the electrical signal, as shown at block 712 of FIG. 7B.

In some examples, the torque value is a peak torque value or a current torque value.

In some examples, the torque value is a peak torque value or a current torque value, and the information read from the electronic torque wrench at block 704 includes the peak torque value and the current torque value.

In some examples, the peak torque value is expressed as a numeric value, and the current torque value is expressed as a bar graph that indicates the current torque value relative to a preset target torque value.

In some examples, the dongle further includes either or both of a loudspeaker or vibrator. In some of these examples, the method 700 further includes causing one or more of the electronic visual display, loudspeaker or vibrator to generate a visual, audible or haptic alert when the torque value reaches a preset target torque value, as shown at block 714 of FIG. 7C.

In some examples, the electronic torque wrench is further configured to determine an angle value of an accumulated angular rotation of the electronic torque wrench during the applied torque. And in some of these examples, the information read from the electronic torque wrench at block 704 also includes the angle value.

In some examples, the angle value is expressed as either or both of a numeric value, or a bar graph that indicates the angle value relative to a preset target accumulated angle value.

In some examples, the dongle further includes a loudspeaker or vibrator. In some of these examples, the method 700 further includes causing the electronic visual display, loudspeaker or vibrator to generate a visual, audible or haptic alert when the angle value reaches a preset target accumulated angle value, as shown at block 716 of FIG. 7D.

In some examples, the second information is a duplicate of the information and includes the torque value.

In some examples, generating the second information includes at block 706 applying the torque value to a function to determine an adjusted torque value. In some of these examples, the second information includes the adjusted torque value, as shown at block 718 of FIG. 7E.

In some examples, the torque value is a peak torque value or a current torque value, and the adjusted torque value is an adjusted peak torque value or an adjusted current torque value.

In some examples, the torque value is a peak torque value and the adjusted torque value is an adjusted peak torque value. In some of these examples, the information read from the electronic torque wrench at block 704 also includes a current torque value. The method 700 then further comprises applying the current torque value to the function to determine an adjusted current torque value, and the second information also includes the adjusted current torque value, as shown at block 720 of FIG. 7F.

In some examples, the adjusted peak torque value is expressed as a numeric value, and the adjusted current torque value is expressed as a bar graph that indicates the current torque value relative to a preset target torque value.

In some examples, the dongle further includes either or both of a loudspeaker or vibrator. In some of these examples, the method 700 further includes causing one or more of the electronic visual display, loudspeaker or vibrator to generate a visual, audible or haptic alert when the adjusted torque value reaches a preset target torque value, as shown at block 722 of FIG. 7G.

In some examples, the dongle is operable in a calibration mode in which the method 700 further includes reading the information including the torque value of the applied torque from the electronic torque wrench, as shown at block 724 of FIG. 7H. And the method includes deriving the function that maps the torque value to a corresponding reference torque value, as shown at block 726.

In some examples, the information including the torque value is read at block 704 for a plurality of applied torques across a rated torque range of the electronic torque wrench. And in some of these examples, the function is derived at block 726 from the torque value and corresponding reference torque values for the plurality of applied torques.

As explained above and reiterated below, the present disclosure includes, without limitation, the following example implementations.

Clause 1. A dongle for an electronic torque wrench configured to determine a torque value of an applied torque, and present information including the torque value, the dongle comprising: a first communication interface that includes a plug configured to fit a receptacle of the electronic torque wrench, and thereby enable data transmission from the electronic torque wrench to the dongle; and a second communication interface that includes an antenna configured to enable data transmission from the dongle to a computer, wirelessly by radio communication; an electronic visual display; and processing circuitry coupled to the first communication interface, the second communication interface and the electronic visual display, the processing circuitry configured to at least: read the information from the electronic torque wrench to the dongle via the first communication interface; generate second information from the information; transmit the second information from the dongle to the computer via the second communication interface; and cause the electronic visual display to present the second information.

Clause 2. The dongle of clause 1, wherein the electronic torque wrench includes separate processing circuitry configured to send an electrical signal that carries the information to a separate electronic visual display on which the information is presented, and wherein the processing circuitry configured to read the information includes the processing circuitry configured to read the electrical signal.

Clause 3. The dongle of clause 1 or clause 2, wherein the torque value is a peak torque value or a current torque value.

Clause 4. The dongle of any of clauses 1 to 3, wherein the torque value is a

peak torque value or a current torque value, and the information the processing circuitry is configured to read from the electronic torque wrench includes the peak torque value and the current torque value.

Clause 5. The dongle of clause 4, wherein the peak torque value is expressed as a numeric value, and the current torque value is expressed as a bar graph that indicates the current torque value relative to a preset target torque value.

Clause 6. The dongle of any of clauses 1 to 5, wherein the dongle further comprises either or both of a loudspeaker or vibrator, and the processing circuitry is further configured to cause one or more of the electronic visual display, loudspeaker or vibrator to generate a visual, audible or haptic alert when the torque value reaches a preset target torque value.

Clause 7. The dongle of any of clauses 1 to 6, wherein the electronic torque wrench is further configured to determine an angle value of an accumulated angular rotation of the electronic torque wrench during the applied torque, and the information read from the electronic torque wrench also includes the angle value.

Clause 8. The dongle of clause 7, wherein the angle value is expressed as either or both of a numeric value, or a bar graph that indicates the angle value relative to a preset target accumulated angle value.

Clause 9. The dongle of clause 7 or clause 8, wherein the dongle further comprises a loudspeaker or vibrator, and the processing circuitry is further configured to cause the electronic visual display, loudspeaker or vibrator to generate a visual, audible or haptic alert when the angle value reaches a preset target accumulated angle value.

Clause 10. The dongle of any of clauses 1 to 9, wherein the second information is a duplicate of the information and includes the torque value.

Clause 11. The dongle of any of clauses 1 to 10, wherein the processing circuitry configured to generate the second information includes the processing circuitry configured to apply the torque value to a function to determine an adjusted torque value, and the second information includes the adjusted torque value.

Clause 12. The dongle of clause 11, wherein the torque value is a peak torque value or a current torque value, and the adjusted torque value is an adjusted peak torque value or an adjusted current torque value.

Clause 13. The dongle of clause 11 or clause 12, wherein the torque value is a peak torque value and the adjusted torque value is an adjusted peak torque value, and wherein the information the processing circuitry is configured to read from the electronic torque wrench also includes a current torque value, the processing circuitry is further configured to apply the current torque value to the function to determine an adjusted current torque value, and the second information also includes the adjusted current torque value.

Clause 14. The dongle of clause 13, wherein the adjusted peak torque value is expressed as a numeric value, and the adjusted current torque value is expressed as a bar graph that indicates the current torque value relative to a preset target torque value.

Clause 15. The dongle of any of clauses 11 to 14, wherein the dongle further comprises either or both of a loudspeaker or vibrator, and the processing circuitry is further configured to cause one or more of the electronic visual display, loudspeaker or vibrator to generate a visual, audible or haptic alert when the adjusted torque value reaches a preset target torque value.

Clause 16. The dongle of any of clauses 11 to 15, wherein the dongle is operable in a calibration mode in which the processing circuitry is further configured to at least: read the information including the torque value of the applied torque from the electronic torque wrench; and derive the function that maps the torque value to a corresponding reference torque value.

Clause 17. The dongle of clause 16, wherein the information including the torque value is read for a plurality of applied torques across a rated torque range of the electronic torque wrench, and the function is derived from the torque value and corresponding reference torque values for the plurality of applied torques.

Clause 18. A method of operating an electronic torque wrench configured to determine a torque value of an applied torque, and present information including the torque value, the method comprising: connecting the electronic torque wrench to a dongle that includes a first communication interface to enable data transmission from the electronic torque wrench to the dongle, and that includes a second communication interface to enable data transmission from the dongle to a computer, wirelessly by radio communication; and at the dongle, reading the information from the electronic torque wrench to the dongle via the first communication interface; generating second information from the information; transmitting the second information from the dongle to the computer via the second communication interface; and causing an electronic visual display of the dongle to present the second information.

Clause 19. The method of clause 18, wherein the electronic torque wrench includes separate processing circuitry configured to send an electrical signal that carries the information to a separate electronic visual display on which the information is presented, and wherein reading the information includes reading the electrical signal.

Clause 20. The method of clause 18 or clause 19, wherein the torque value is a peak torque value or a current torque value.

Clause 21. The method of any of clauses 18 to 20, wherein the torque value is a peak torque value or a current torque value, and the information read from the electronic torque wrench includes the peak torque value and the current torque value.

Clause 22. The method of clause 21, wherein the peak torque value is expressed as a numeric value, and the current torque value is expressed as a bar graph that indicates the current torque value relative to a preset target torque value.

Clause 23. The method of any of clauses 18 to 22, wherein the dongle further includes either or both of a loudspeaker or vibrator, and the method further comprises causing one or more of the electronic visual display, loudspeaker or vibrator to generate a visual, audible or haptic alert when the torque value reaches a preset target torque value.

Clause 24. The method of any of clauses 18 to 23, wherein the electronic torque wrench is further configured to determine an angle value of an accumulated angular rotation of the electronic torque wrench during the applied torque, and the information read from the electronic torque wrench also includes the angle value.

Clause 25. The method of clause 24, wherein the angle value is expressed as either or both of a numeric value, or a bar graph that indicates the angle value relative to a preset target accumulated angle value.

Clause 26. The method of clause 24 or clause 25, wherein the dongle further includes a loudspeaker or vibrator, and the method further comprises causing the electronic visual display, loudspeaker or vibrator to generate a visual, audible or haptic alert when the angle value reaches a preset target accumulated angle value.

Clause 27. The method of any of clauses 18 to 26, wherein the second information is a duplicate of the information and includes the torque value.

Clause 28. The method of any of clauses 18 to 27, wherein generating the second information includes applying the torque value to a function to determine an adjusted torque value, and the second information includes the adjusted torque value.

Clause 29. The method of clause 28, wherein the torque value is a peak torque value or a current torque value, and the adjusted torque value is an adjusted peak torque value or an adjusted current torque value.

Clause 30. The method of clause 28 or clause 29, wherein the torque value is a peak torque value and the adjusted torque value is an adjusted peak torque value, and wherein the information read from the electronic torque wrench also includes a current torque value, the method further comprises applying the current torque value to the function to determine an adjusted current torque value, and the second information also includes the adjusted current torque value.

Clause 31. The method of clause 30, wherein the adjusted peak torque value is expressed as a numeric value, and the adjusted current torque value is expressed as a bar graph that indicates the current torque value relative to a preset target torque value.

Clause 32. The method of any of clauses 28 to 31, wherein the dongle further includes either or both of a loudspeaker or vibrator, and the method further comprises causing one or more of the electronic visual display, loudspeaker or vibrator to generate a visual, audible or haptic alert when the adjusted torque value reaches a preset target torque value.

Clause 33. The method of any of clauses 28 to 32, wherein the dongle is operable in a calibration mode in which the method further comprises: reading the information including the torque value of the applied torque from the electronic torque wrench; and deriving the function that maps the torque value to a corresponding reference torque value.

Clause 34. The method of clause 33, wherein the information including the torque value is read for a plurality of applied torques across a rated torque range of the electronic torque wrench, and the function is derived from the torque value and corresponding reference torque values for the plurality of applied torques.

Many modifications and other implementations of the disclosure set forth herein will come to mind to one skilled in the art to which the disclosure pertains having the benefit of the teachings presented in the foregoing description and the associated figures. Therefore, it is to be understood that the disclosure is not to be limited to the specific implementations disclosed and that modifications and other implementations are intended to be included within the scope of the appended claims. Moreover, although the foregoing description and the associated figures describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation

What is claimed is:

1. A dongle for an electronic torque wrench configured to determine a torque value of an applied torque, and present information including the torque value, the dongle comprising:
a first communication interface that includes a plug configured to fit a receptacle of the electronic torque wrench, and thereby enable data transmission from the electronic torque wrench to the dongle; and
a second communication interface that includes an antenna configured to enable data transmission from the dongle to a computer, wirelessly by radio communication;
an electronic visual display; and
processing circuitry coupled to the first communication interface, the second communication interface and the electronic visual display, the processing circuitry configured to at least:
read the information from the electronic torque wrench to the dongle via the first communication interface;
generate second information from the information;
transmit the second information from the dongle to the computer via the second communication interface; and
cause the electronic visual display to present the second information.

2. The dongle of claim 1, wherein the electronic torque wrench includes separate processing circuitry configured to send an electrical signal that carries the information to a separate electronic visual display on which the information is presented, and
wherein the processing circuitry configured to read the information includes the processing circuitry configured to read the electrical signal.

3. The dongle of claim 1, wherein the torque value is a peak torque value or a current torque value, and the information the processing circuitry is configured to read from the electronic torque wrench includes the peak torque value and the current torque value.

4. The dongle of claim 3, wherein the peak torque value is expressed as a numeric value, and the current torque value is expressed as a bar graph that indicates the current torque value relative to a preset target torque value.

5. The dongle of claim 1, wherein the dongle further comprises either or both of a loudspeaker or vibrator, and the processing circuitry is further configured to cause one or more of the electronic visual display, loudspeaker or vibrator to generate a visual, audible or haptic alert when the torque value reaches a preset target torque value.

6. The dongle of claim 1, wherein the electronic torque wrench is further configured to determine an angle value of an accumulated angular rotation of the electronic torque wrench during the applied torque, and the information read from the electronic torque wrench also includes the angle value.

7. The dongle of claim 1, wherein the processing circuitry configured to generate the second information includes the processing circuitry configured to apply the torque value to a function to determine an adjusted torque value, and the second information includes the adjusted torque value.

8. The dongle of claim 7, wherein the torque value is a peak torque value and the adjusted torque value is an adjusted peak torque value, and
wherein the information the processing circuitry is configured to read from the electronic torque wrench also includes a current torque value, the processing circuitry is further configured to apply the current torque value to the function to determine an adjusted current torque value, and the second information also includes the adjusted current torque value.

9. The dongle of claim 8, wherein the adjusted peak torque value is expressed as a numeric value, and the adjusted current torque value is expressed as a bar graph that indicates the current torque value relative to a preset target torque value.

10. The dongle of claim 7, wherein the dongle further comprises either or both of a loudspeaker or vibrator, and the processing circuitry is further configured to cause one or more of the electronic visual display, loudspeaker or vibrator to generate a visual, audible or haptic alert when the adjusted torque value reaches a preset target torque value.

11. A method of operating an electronic torque wrench configured to determine a torque value of an applied torque, and present information including the torque value, the method comprising:
connecting the electronic torque wrench to a dongle that includes a first communication interface to enable data transmission from the electronic torque wrench to the dongle, and that includes a second communication interface to enable data transmission from the dongle to a computer, wirelessly by radio communication; and at the dongle,
reading the information from the electronic torque wrench to the dongle via the first communication interface;
generating second information from the information;
transmitting the second information from the dongle to the computer via the second communication interface; and
causing an electronic visual display of the dongle to present the second information.

12. The method of claim 11, wherein the electronic torque wrench includes separate processing circuitry configured to send an electrical signal that carries the information to a separate electronic visual display on which the information is presented, and
wherein reading the information includes reading the electrical signal.

13. The method of claim 11, wherein the torque value is a peak torque value or a current torque value, and the information read from the electronic torque wrench includes the peak torque value and the current torque value.

14. The method of claim 13, wherein the peak torque value is expressed as a numeric value, and the current torque value is expressed as a bar graph that indicates the current torque value relative to a preset target torque value.

15. The method of claim 11, wherein the dongle further includes either or both of a loudspeaker or vibrator, and the method further comprises causing one or more of the electronic visual display, loudspeaker or vibrator to generate a visual, audible or haptic alert when the torque value reaches a preset target torque value.

16. The method of claim 11, wherein the electronic torque wrench is further configured to determine an angle value of an accumulated angular rotation of the electronic torque wrench during the applied torque, and the information read from the electronic torque wrench also includes the angle value.

17. The method of claim 11, wherein generating the second information includes applying the torque value to a function to determine an adjusted torque value, and the second information includes the adjusted torque value.

18. The method of claim 17, wherein the torque value is a peak torque value and the adjusted torque value is an adjusted peak torque value, and
wherein the information read from the electronic torque wrench also includes a current torque value, the method further comprises applying the current torque value to the function to determine an adjusted current torque value, and the second information also includes the adjusted current torque value.

19. The method of claim 18, wherein the adjusted peak torque value is expressed as a numeric value, and the adjusted current torque value is expressed as a bar graph that indicates the current torque value relative to a preset target torque value.

20. The method of claim 17, wherein the dongle further includes either or both of a loudspeaker or vibrator, and the method further comprises causing one or more of the electronic visual display, loudspeaker or vibrator to generate a visual, audible or haptic alert when the adjusted torque value reaches a preset target torque value.
